(19) United States
(12) Patent Application Publication
(10) Pub. No.: US 2007/0005659 A1
(43) Pub. Date: Jan. 4, 2007

(54) Data deletion method, storage device, and computer system

(75) Inventors: Damien Lemoal, Sagamihara (JP); Mika Mizutani, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/325,016

(22) Filed: Jan. 3, 2006

(30) Foreign Application Priority Data
Jun. 29, 2005 (JP) 2005-189158

(51) Int. Cl. G06F 17/30

(52) U.S. Cl. 707/200

(57) ABSTRACT

Complete data deletion from a storage device imposes high loads respectively on a host computer for transfer of insignificant data and on a storage device for execution of data transfer, a write operation, and a retry process. As such, a complete deletion command is provided to control deletion of a specified area of a storage space of the storage device without requiring data transfer from the host computer to the storage device. The complete deletion command on the storage device is executed in a simple manner that a write operation is performed to write “arbitrary data” over data of an area specified in, for example, a delete command, by a controller of the storage device, whereby the complete deletion of the specified data is executed. Consequently, a file system is enhanced to enable an application to execute the complete deletion command (“complete file data detection function”).

### CLAIM OF PRIORITY

The present application claims priority from Japanese application P2005-189158 filed on Jun. 29, 2005, the content of which is hereby incorporated by reference into this application.

### BACKGROUND OF THE INVENTION

1. Field of the Invention

The present invention relates to a technique of completely deleting data from a storage device without imposing high loads on either of a storage device and a host computer. More specifically, the invention relates to a deletion technique that serves while restraining performance degradation of the entirety of the storage device and host computer.

2. Description of the Related Art

File systems are main element techniques that systematically controls data being stored in storage devices such as disk devices.

According to conventional methods, deletion of data contained in a file is, generally, performed by just deleting references to data of the file and to the file itself from control data of a file system. Real deletion of stored data is not involved, such that the file deletion is resultantly a very fast process. A conventional method, such as described above, thus delete just the references. As such, the method obviates a large number of commands, which are issued to the storage device for deletion of actual data, thereby reducing burdens on deletion, read, write, and other file operations.

However, such the conventional final deletion method is not yet sufficient in regard to application to security sensitive data or access-restricted data (i.e., data secured or protected by copyright laws and other control laws for the maximum number of accesses). Data of video contents of cable or radio broadcasts are often protected by control laws as mentioned above.

Considerations regarding security for handling copyright-protected contents or standards therefor in foreign countries are given to subject to conditions requiring that data deletion is to be complete, or in other words, data is not to be allowed to be reproduced from a deleted file even in the event of direct sequential access to the storage device.

An example satisfying such conditions is that data of a deletion objective file is overwritten with arbitrary, non-associated, insignificant data (“0”, for example) (as disclosed in Japanese Unexamined Patent Application Publication No. 1993-53891). The disclosed method is very simple, and can be enforced by an arbitrary application that processes security data of the above-described type. However, the method requires that time-consuming long, burdensome processing for transferring data intended to be written to the storage device from a host computer (or “host,” hereafter), in which an other process, if any, has to wait for completion of the write operation. The amount of data to be transferred and written is the same as the size of a deletion file. Loads occurring in this case are not tolerable in many events involving, particularly, a very large file, such as a video file containing a high resolution video.

Further, not a few cases can take place in which the designated storage device, such as the magnetic disk device, is prone to error, consequently causing intervention of a time consuming error recovery process (retry process) for a write operation until appropriate completion of an issued write command. According to the conventional technique, a difference does not exist at all between a real data write operation and a write operation for overwriting (deleting) security sensitive data, such that processing of the identical write operations are performed by the magnetic disk device. Consequently, cases involving retry processes can take place.

Such a retry process is likely to be a long-time consuming process, such that a state occurs in which the storage device cannot be used for a long time for an other process. This consequently introduces a delay in the execution of an other command, thereby reducing the data access rate of the storage device.

According to the technique disclosed in Japanese Unexamined Patent Application Publication No. 1993-5389, in the event of deletion of a file stored on the magnetic disk, it is determined whether the file is a security protection file. If the file is determined to be a security protection file, then a storage area storing the file is, detected, and information stored in that area is deleted. Subsequently, the information of the file is deleted in accordance with file control information, thereby to perform logical deletion of the file. On the other hand, if the file is determined to be not a security protection file, then only theoretical deletion is performed, and information deletion is not performed. There is not given a slight consideration regarding loads that occur due to the data transfer and increase of loads on a CPU (central processing unit) in the event of “information deletion.”

The complete data deletion from the storage device imposes such high loads respectively on the host computer for transfer of insignificant data (“0”, for example) and on the storage device for execution of data transfer and write operations, and finally, retry process.

Video data such as high resolution video contents are ordinary data that users operate. In view of salient trends toward increase of such video data, loads occurring with the data deletion of the above-described type cannot be solved by the conventional technique. In particular, in a data storage system, such as a video recorder device or set-top box including a magnetic disk device, the appropriate operation of the entire system is very sensitive to the performance of its incorporated storage device. In such a device, an excessively large amount of load occurs with the conventional data deletion method, so that the loads are not tolerable.

Nevertheless, however, storage systems of the type described above are used to handle video contents and other data protected by control laws (copyright laws), so that complete data deletion has to be implemented therewith

### SUMMARY OF THE INVENTION

The present invention is made to provide a new or novel command (complete deletion command) for controlling a storage device in order to accomplish the complete deletion of a file.

The complete deletion command is capable of controlling deletion of a specified area of a storage space of a storage device without requiring data transfer from a host to the storage device. The complete deletion command on the storage device is executed in a simple manner that a write operation is performed to write “arbitrary data” over data of an area specified in, for example, a delete command, by a controller of the storage device. Thereby, the complete deletion of the specified data is executed.

In this case, even when an error of mismatched written data is found as a result of comparison with “arbitrary data,” since the original data is overwritten with the “arbitrary data” and is held an unreadable state, retry and other processes such as the error recovery process do not have to be performed. This often applies to disk storage devices of a type using rotary recording medium that involves irreversible shifting of a storage area on which a write operation is performed such that a magnetic field appropriately is applied or a laser beam is appropriately irradiated from an area (storage area or block) of the disk.

Consequently, the file system is enhanced to enable an application to execute the complete deletion command (“complete file data detection function”).

The complete deletion command has the following effects and advantages:

(a) Unlike the conventional overwrite operation, data transfer between the storage device and the host computer for the data deletion is not necessary, it is possible to reduce both the load on an I/O bus of a host computer and the load on a storage device controller to handle data. Thereby, as in the cases of memories of the host computer and the storage device controller, in the event of an overwrite operation, consumption of memory resources necessary to store data to be transferred between the host computer and the storage device is reduced as well.

(b) It is not difficult to install a “complete file data deletion function” (or, “complete delete function”) into an application, and it is sufficient for the application only to execute a single function provided by a file system. Execution of the complete delete function causes a single or a multiple delete commands to be issued to the storage device, whereby data is effectively completely deleted from the storage device.

In the event of deletion of data from the storage device, the present invention reduces the load on the controller of the device and the load on the host computer using the device, thereby to improve the access speed of the entirety of the device.

### BRIEF DESCRIPTION OF THE DRAWINGS

FIG. 1 is a view of a typical hardware configuration of a system including a magnetic disk device and allowing the adaptation of a security-data complete deletion technique or method according to the present invention;

FIG. 2 is a conceptual view showing that a file system controls a file by segmenting the file into mutually adjacent logical blocks having fixed sizes;

FIG. 3 is a view showing information of a file and the structure thereof that are handled by the file system;

FIG. 4 is a view descriptive of the state of execution of a complete deletion command for file data;

FIG. 5 is a diagram showing a detailed follow of processes that are executed by the file system to completely delete the file;

FIG. 6 shows a diagram showing the structure of a complete deletion command to be issued to a magnetic disk device, and a diagram showing the flow of generation of the command; and

FIG. 7 is a diagram showing a complete deletion command and diagram showing the flow of a process of an other command in the magnetic disk device.

### DETAILED DESCRIPTION OF THE EMBODIMENTS

An embodiment of the present invention will be described herebelow.

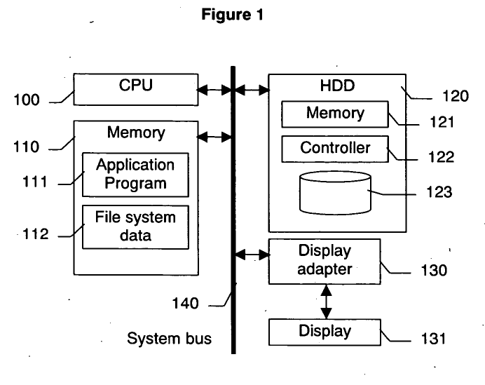

FIG. 1 discloses a computer system including a magnetic disk device and allowing the adaptation of security-data complete deletion method according to the present invention.

In the computer system, under control of a central processing unit 100 (“CPU,” hereafter), an application 111 in a main memory 110 uses a file system 112 resident in the main memory 110 to thereby issue commands to a magnetic disk device 120. The magnetic disk device 120 includes a local memory 121 and a controller 122 that controls access to data stored on a magnetic disk medium 123.

The CPU 100 passes the respective commands to the magnetic disk device 120 through a system bus 140. A display 131 is able to display data process results through a display adapter 130.

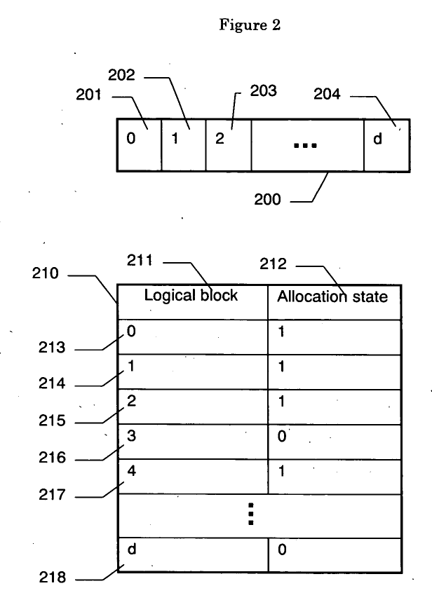

FIG. 2 is a conceptual view showing that the file system 112 performs control by segmenting a storage space 200 (file) into mutually adjacent logical blocks 201 to 204 having fixed sizes.

The respective blocks are identified using numbers 0(201) to d(204) (logical block numbers). Thereby, direct mapping of the logical block numbers 0(201) to d(204) and addresses of physical blocks on the medium magnetic disk can be instantiated in a simple manner. The file system 112 uses a logical block allocation table 210 provided for controlling an allocation state 212 of each respective logical block 211, thereby to indicate whether, for example, a logical block 213 includes valid data.

In the present embodiment, logical blocks 0(213), 1(214), 2(215), and 4(217) are used. More specifically, the logical blocks 0(213), 1(214), 2(215), and 4(217) are in allocated states to store system data of the file system 112 or data. Logical blocks 3(216) and d(218) are in unused states and are usable to store data. A table 200 (itself) is stored with a single or plurality of logical blocks on the medium magnetic disk, and correlations between logical blocks and physical blocks can be retained even after the system has been powered off.

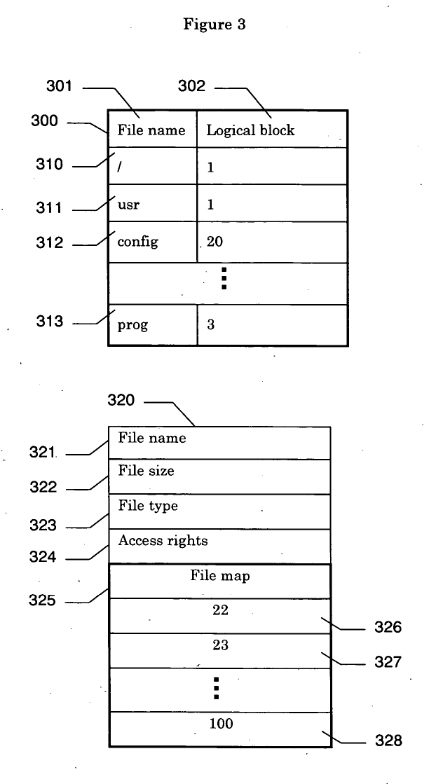

FIG. 3 is a view showing information of a file and the structure thereof that are handled by the file system 112.

A file table 300 contains a file name 301 and control information 310 to 313 regarding each respective file. Logical blocks 302 are recorded with data corresponding to the respective control information. A file information table 320 and the file table 300 themselves are stored on the magnetic disk, and correlations between logical blocks and physical blocks can be retained.

The file information table 320 contains file descriptors, namely, a file name 321, a file size 322, a file type 323, and file access rights 324, and other information. The block of the file access rights 324 is used to store information regarding protection of data contained in the file, and information indicative of whether to require complete data deletion when the file is discarded.

The file information table 320 additionally stores a file map 325 indicative of the numbers of logical blocks used to stored data. The file map 325 is used to directly map a file offset (address of data in the file) to a physical block address of the magnetic disk medium.

For example, data of an offset 0 in a file is stored on a corresponding medium magnetic disk via a logical block 22(326). Data of an offset identical to the size of the logical block is stored on the corresponding medium magnetic disk via a logical block 23(327). The last data of the file is stored on the corresponding medium magnetic disk via a logical block 100(328).

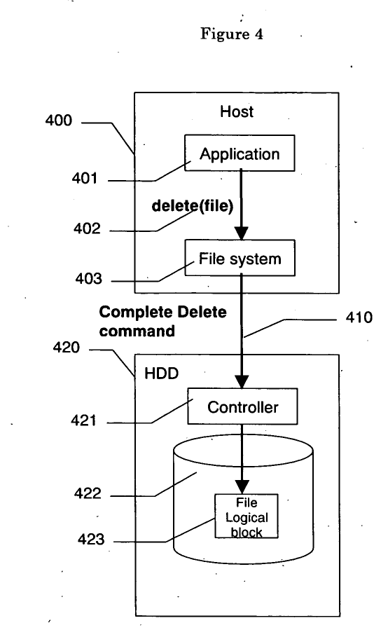

The data structure described above enables simple mapping between the logical block address of the file data (data offset in the file) and the physical block address. The mapping is used in a manner as shown in FIG. 4, particularly, upon request from an application.

FIG. 4 is a view descriptive of the state of execution of a complete deletion command for file data. The case shown is assumed in which a request 402 for the complete deletion is issued to a file system 403 from an application 401 currently being executed in a host 400. In this case, the file system 403 responsively-acquires logical block addresses, which constitute the file, by using a file descriptor, and then issues a complete deletion command 410 for respective logical blocks 423.

A controller 421 of the magnetic disk device 420 processes the received delete command 410. Then, in accordance with specifications of the received command 410, the controller 421 deletes data of physical blocks that have the contents of all specified logical blocks 423 stored on a magnetic disk device 422.

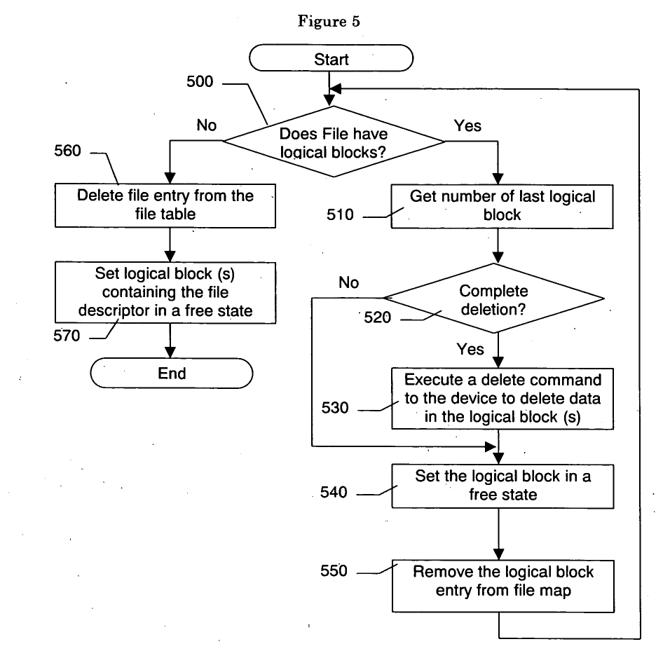

FIG. 5 shows a detailed follow of processes that are executed by the file system to completely delete the file. The processes can be applied either a file for which the data complete deletion is not required or to a file for which security is not taken into account.

First, a file size 322 is checked, and it is determined whether the file is empty or has logical blocks (at step 500). If the file is empty (“No”), then an entry of the file in a file table 200 is deleted (at step 560). A logical block including a file descriptor (file name 321, file size 322, file type 323, access rights 324, and file map 325) is set to a free state, and the file is freed (at step 570).

Alternatively, if the file is not empty (“Yes” at step 500), then steps described below are executed until logical blocks registered in a file map contained in the file are deleted. To begin with, a last logical block number in the file map is acquired from the map (at step 510). In the event that the requested file deletion method is the complete deletion-(“Yes” at step 520), a delete command 410 is issued to the magnetic disk device 420 from the controller 421 (shown in FIG. 4) to completely delete data stored in the logical block (at step 530), whereby the data is deleted. Upon completion of the command execution, the processed logical block is set to a free state (at step 540), the number of the block is removed from the file map (at step 550). On the other hand, in the event that the file complete deletion is not requested (“No”) at step 520), the same steps as above performed without issuance of the complete deletion command 410 to the magnetic disk device 420. If the file map becomes empty (“No” at step 500), then the entry of the file registered in the file table 200 is removed (at step 560), and the logical block containing the file descriptor is freed (at step 570).

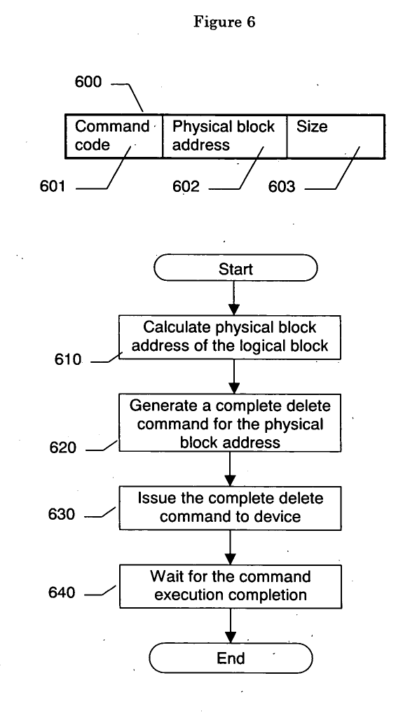

FIG. 6 shows a diagram showing the structure of a complete deletion command 600 to be issued to the magnetic disk device, and the flow of generating the command 600. The complete deletion command 600 is identified with a command code 601, and is configured of a field 602 that stores a physical block address, and a field 603 that specifies a deletion objective area that is started from a specified address.

The complete deletion command 600 is generated by the file system with respect to a respective logical block requiring the complete deletion. Using a logical block number (602) of the deletion objective file, the file system calculates a physical block address of the logical block (at step 610). The size of the deletion area is the same as the size of the logical block. The file system generates a complete deletion command 600 for deleting the physical block (at step 620) and issues the complete deletion command 600 to the magnetic disk device (at step 630). The magnetic disk device waits for completion of the received command 600 (at step 640), and upon completion, posts a notification of completion of the complete deletion command 600. Then, the flow terminates.

The step of waiting (at step 640) implies that a command other than the complete deletion command is executed with precedence in accordance with a so-called a command queuing technique. The waiting is, therefore, unnecessary in the event the command queuing technique is not used. The command priority can be determined by, for example, command code 601. Suppose now that a command with a priority level higher than the complete deletion command during execution of the complete deletion command is issued in a step (not shown). In this case, the process may be performed in the manner that the execution of the complete deletion command is suspended, the other command is instead executed, and the complete deletion command is reexecuted upon completion of the execution of the other command.

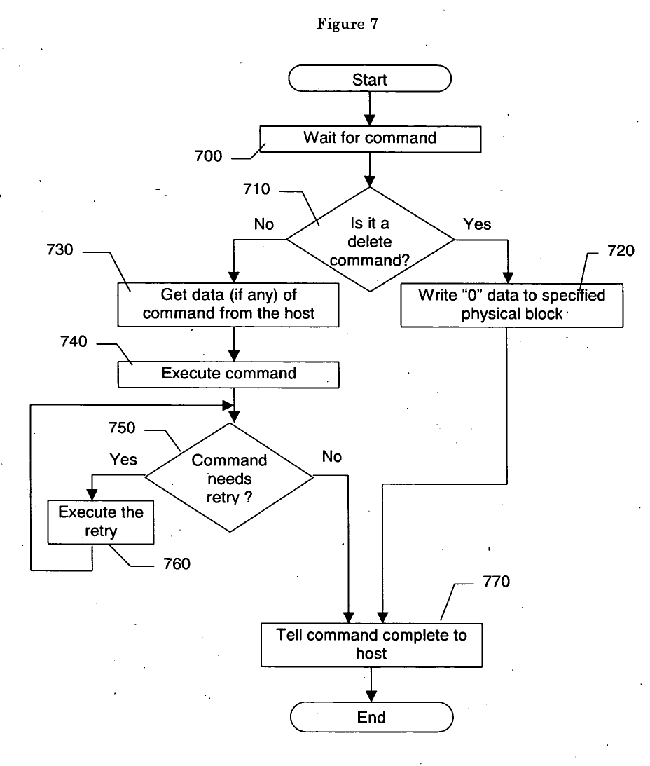

FIG. 7 shows the flow of a process of the complete deletion command and an other command in the magnetic disk device.

The controller 122 (shown in FIG. 1) of the magnetic disk device 120 waits for commands incoming from the host (at step 700). Commands the controller 122 include conventional a readout or write command, present inventive command, and other necessary command for the magnetic disk device 120.

If a received command is a complete deletion command (“Yes” at step), the controller 122 writes data specified in the command, specifically, a data amount of “0” or randomly selected data over a physical block of an address specified in the command (at step 720). The result of a write operation need not be checked because accuracy of the write data (accurate identity between the written data and intended write data) cannot be required.

In this manner, original data present on the magnetic disk medium is replaced by “0” or randomly selected arbitrary data, such that complete deletion of the original data is resultantly implemented. Even if part of the deletion is incomplete, the probability of retrieving the original data is extremely low.

Upon completion of the operation of completion deletion, the execution completion of the complete deletion command is notified to the host (at step 770).

In comparison with the above-described simple operation for the complete deletion command, the other command, particularly, the write command is processed by initially acquiring from the host all data necessary to write to the magnetic disk device (at step 730). Subsequently, data is written onto the magnetic disk device, or alternatively, data is read out from the magnetic disk device in the event of the read command (at step 740). Thereafter, the execution results of the commands are verified, and it is determined whether a process such as retry or error recovery process is necessary (at step 750). The operation for the retry process is iterated several times, and then the flow terminates (at step 760).

Upon completion of the command, the completion is notified to the host (at step 770).

The process flow explicitly indicates advantages of the complete deletion command of the present invention that completely deletes data stored on the magnetic disk device. In the event of the complete deletion command, neither data transfer between the host and the controller nor an error recovery process is necessary.

The present invention thus described can be adapted to disk storage devices using a rotary recording medium, in which a magnetic field is appropriately applied to a predetermined area or a laser beam is appropriately irradiated thereon to irreversibly change the area, thereby to record information.

Having described a preferred embodiment of the invention with reference to the accompanying drawings, it is to be understood that the invention is not limited to the embodiment and that various changes and modifications could be effected therein by one skilled in the art without departing from the spirit or scope of the invention as defined in the appended claims.

What is claimed is:

1. A data deletion method for a computer system having a central processing unit (“CPU”, hereinafter), a memory connected to the CPU to be accessible, and a storage device using a rotary recording medium, wherein:
the computer system includes a function of deleting data of a file which data is written by a file system on the rotary recording medium through the CPU, the file system being expanded on the memory;
the storage device includes a controller including a function of overwriting the data of the file, which is written on the rotary recording medium, with arbitrary data; and
the file system includes a function of sending a command to the storage device upon being accessed from an application expanded on the memory, the command overwriting data of a file with arbitrary data,
the data deletion method comprising:
a first step wherein the application issues to the file system a request for deleting the file;
a second step wherein the file system sends to the controller a command(s) for performing overwriting with one item of or a plurality of items of the arbitrary data for the file; and
a third step wherein, in response to the command from the file system, the controller performs overwriting of data of the file that is written on the rotary recording medium.

2. A data deletion method according to claim 1, wherein the command for performing overwriting with one item of or the plurality of items of the arbitrary data for the file is issued with respect to each of logical blocks of the file segmented into a plurality of logical blocks.

3. A data deletion method according to claim 1, wherein the file system deletes a reference of a file requested by the application for deletion.

4. A data deletion method according to claim 1, wherein an error recovery process is not performed on the data overwritten in the third step.

4. A data deletion method according to claim 1, further comprising:
a fourth step wherein the file system issues an other command to the controller during the overwriting in the third step; and
a fifth step wherein the controller executes the other command with priority over the overwriting in the third step.

6. A storage device, comprising:
a memory;
a rotary recording medium; and
a controller including a function of overwriting data of a file, which is stored on the rotary recording medium, with arbitrary data.

7. A computer system having a CPU (central processing unit), a memory connected to the CPU to be accessible, and a storage device using a rotary recording medium, wherein:
the storage device includes a controller including a function of overwriting the data of the file, which is written on the rotary recording medium, with arbitrary data; and
the file system expanded on the memory includes a command that upon being accessed from an application expanded on the memory, instructs the storage device through the CPU to overwrite data of a file that is written on the rotary recording medium.
